(19) United States
(12) Patent Application Publication
(10) Pub. No.: US 2012/0104320 A1
(43) Pub. Date: May 3, 2012

(54) LUMINESCENT PAINTS AND METHODS OF MAKING THE SAME

(76) Inventor: David Postma, Hobart, IN (US)

(21) Appl. No.: 13/383,650

(22) PCT Filed: Mar. 30, 2010
(86) PCT No.: PCT/US10/29203

§ 371 Date: Jan. 12, 2012

Related U.S. Application Data
(60) Provisional application No. 61/226,327, filed on Jul. 17, 2009.

(51) Int. Cl. C09D 5/22

(52) U.S. Cl. 252/301.36

(57) ABSTRACT

Luminescent paints and methods of making luminescent paints are provided. In some examples, the luminescent paints may include urethane resin and luminescent substance. The luminescent paints may also include a variety of day time, UV stable colors, thereby providing the luminescent paints with long lasting and vibrant day time colors. Also, the luminescent paints may be bio-friendly in nature and may include low levels of hazardous air pollutants (HAPs) or no HAPs at all.

### RELATED APPLICATIONS

The present application claims the benefit of co-pending U.S. Provisional Patent Application No. 61/226,327, filed Jul. 17, 2009, the entire contents of which is incorporated herein by reference.

### FIELD OF THE INVENTION

The present invention generally relates to paints and, more particularly, to luminescent paints having color.

### BACKGROUND

Conventional luminescent paints are typically acrylic in nature and may either be water or solvent based acrylics. Due to the nature of acrylic based luminescent paints, these luminescent paints lack durability and are brittle when dry. When applied to a surface, these acrylic based luminescent paints wear quickly or may begin to crack, flake, peel, or crumble, and therefore chip away. In addition, the color capabilities of acrylic based luminescent paints are limited because the water based dyes compatible with such acrylic based luminescent paints are not ultraviolet (UV) stable and will fade in a relatively short period of time (e.g., 2 months) with exposure to ultraviolet rays (e.g., sunlight or artificial light). Some acrylic based luminescent paints may include a UV inhibitor to inhibit fading of the color. However, such UV inhibitors reduce the effectiveness of the luminescent aspect of the paint because the UV rays are required to activate the luminescent substance within the paints and the UV rays cannot access the luminescent substance due to the UV inhibitor.

The types of surfaces to which acrylic based luminescent paints may be applied are limited by the characteristics of these paints. For example, due to the low durability of acrylic based luminescent paints, it is undesirable to apply these luminescent paints in high traffic areas. Also, for example, due to the brittleness of the acrylic based luminescent paints, it is undesirable to apply these luminescent paints to objects that may flex or otherwise deform, or to objects that may be impacted. Application of conventional acrylic luminescent paints to such objects will cause the conventional acrylic luminescent paints to flex, crack or break, and ultimately chip away.

Conventional luminescent paints may have high levels of hazardous air pollutants (HAPs), which may be detrimental to the environment and to people that come into contact with or close proximity of such conventional luminescent paints. More particularly, HAPs, also known as toxic air pollutants or air toxics, are those pollutants that cause or may cause cancer or other serious health effects, such as reproductive effects or birth defects, or adverse environmental and ecological effects. Currently, the Environmental Protection Agency (EPA) is required to control 187 HAPs. Through rulemaking, the original 1990 list of HAPs has been modified 8 times to date. A current list of HAPs and modifications can be found at www.epa.com.

HAPs are generally in the form of solvents and when the solvents of the conventional paints evaporate, the HAPs are released into the air/environment. HAPs have been determined by many scientists to provide a negative impact on the environment when released into the air and on people applying the paint due to inhalation risks. Additionally, excess paint is commonly disposed of by dumping it on the ground or washing it down the sewer. Due to the high levels of HAPs in the paint, both of these disposal methods have a negative impact on the environment.

### SUMMARY

The present invention resolves shortcomings of the prior art.

In one example, a luminescent paint is provided.

In another example, a method of making a luminescent paint is provided.

In a further example, a urethane based luminescent paint is provided.

In yet another example, a method of making a urethane based luminescent paint is provided.

In yet a further example, a urethane based luminescent paint is provided and includes a urethane base, an anti-settling agent, and a luminescent substance.

In a still further example, a method of making a luminescent paint is provided and includes providing a quantity of an anti-settling agent, mixing a quantity of urethane base with the quantity of anti-settling agent, and mixing a quantity of luminescent substance with the mixture of anti-settling agent and urethane base.

In another example, a urethane based luminescent paint is provided with a low level of hazardous air pollutants (HAPs).

In a further example, a urethane based luminescent paint is provided and has a low percentage by total weight of HAPs.

In yet another example, a urethane based luminescent paint is provided and has no HAPs.

In yet a further example, a urethane based luminescent paint is provided and has a zero percentage by total weight of HAPs.

In a still further example, a luminescent paint is provided and has a composition comprising, as a percentage of weight, about 5% to about 65% urethane resin, about 0.001% to about 60% luminescent substance, and less than or equal to about 5% hazardous air pollutant.

In another example, a luminescent paint composition is provided and includes urethane resin, luminescent substance, and a solvent derived from at least one of corn, soy, citrus, and vegetable.

### BRIEF DESCRIPTION OF THE DRAWINGS

FIG. 1 is a perspective view of an exemplary environment in which urethane based luminescent paint embodying the present invention may be applied, the exemplary environment comprises a building stairwell including stairs, a handrail, a landing, a riser, a door frame, a sign, and other elements associated with a stairwell;

FIG. 2 is a perspective view of another exemplary environment in which the urethane based luminescent paint may be applied, the exemplary environment comprising a hard hat;

FIG. 3 is a cross-sectional schematic of an exemplary application of the urethane based luminescent paint to an exemplary object; and

FIG. 4 is a flowchart illustrating an exemplary manner of making a urethane based luminescent paint.

Before any independent features and embodiments of the invention are explained in detail, it is to be understood that the invention is not limited in its application to the details of the construction and the arrangement of the components set forth in the following description or illustrated in the drawings. The invention is capable of other embodiments and of being practiced or of being carried out in various ways. Also, it is understood that the phraseology and terminology used herein is for the purpose of description and should not be regarded as limiting.

### DETAILED DESCRIPTION

Luminescent paints of the present invention are usable in a variety of different applications and may be applicable to a variety of different objects and materials. The luminescent paints absorb and in return emit light, which may be helpful for illuminating environments having low light conditions, and are durable, thereby resisting wear and providing a long effective life. Also, the luminescent paints may have a variety of colors capable of maintaining their vividness after exposure to light over long periods of time. Such luminescent paints may comprise a urethane base. The use of the urethane base provides the luminescent paints with improved durability and improved impact resistance over conventional acrylic based luminescent paints. In addition, urethanes have been proven to have superior structural flexibility, superior bonding, superior compatibility with other products (e.g., primers, top coats, etc.), and a significantly longer life then acrylics based paints. Further, the present urethane based luminescent paints may be applied to surfaces in a wider range of climate conditions. For example, the urethane based luminescent paints may be effectively applied to surfaces in relatively low temperatures such as below 50° Fahrenheit. If acrylic based luminescent paints are applied to surfaces at temperatures below 50° Fahrenheit, the paint will not cure. Further yet, the urethane based luminescent paints may have a wide variety of colors resistant to fading.

The urethane based luminescent paints may be applied to flexible or semi-flexible objects and withstand flexing of the objects or impacts to the objects without cracking, chipping, or peeling of the paint from the objects. Conventional acrylic based luminescent paints are very brittle and crack, chip, or peel when applied to flexible or semi-flexible objects. The urethane based luminescent paints have sufficient elasticity to accommodate flexing of the object to which the paint is applied.

The urethane based luminescent paints may include a luminescent substance that provides the luminescent properties of the luminescent paints. The luminescent substance may be a variety of different substances such as, for example, strontium aluminate doped with europium (SrAl₂O₄:Eu) or copper-activated zinc sulfide (ZnS:Cu). In some examples, the urethane based luminescent paints may also include an anti-settling agent. The anti-settling agent inhibits the particulate within the paint from settling to a bottom of a container and solidifying to an extent where the paint is unusable. Also, in some examples, the urethane based luminescent paints may include dyes for coloring the luminescent paint to desired colors. Exemplary colors include, but are not limited to, blue, light blue, green, light green, blue-green, yellow, fluorescent yellow, safety yellow, orange, red, and purple. In some instances, it may be desired for the luminescent paints to be white in color, in which case no dye is added to the paints.

The urethane based luminescent paints may be used in a variety of exemplary applications such as, for example: floors; walls; door frames; doors; handrails; stairs; various interior and exterior portions of automobiles and other motorized vehicles such as wheel rims, body paint, truck beds, calipers, etc.; various interior and exterior portions of trailers and other non-motorized vehicles; heavy machinery or equipment; personal safety equipment such as hard hats and vests; transformers; power boxes; signs such as road signs, informational signs, and safety signs; electric service panels; tool boxes; fire hydrants; fire extinguishers; fire extinguisher cabinets; parking lot indicia; roadway indicia; airport runway indicia; bicycle path indicia; curbs; exterior and interior portions of buildings; floor boards and base boards; light fixtures; bollards; construction related implements such as road cones, barrels, barriers and J-walls; various interior and exterior portions of police and fire departments; etc. In addition, urethane based luminescent paints may be applied to a variety of different materials such as, for example, metal, plastic, concrete, asphalt, drywall, glass, wood, ceramics, porcelain, etc.

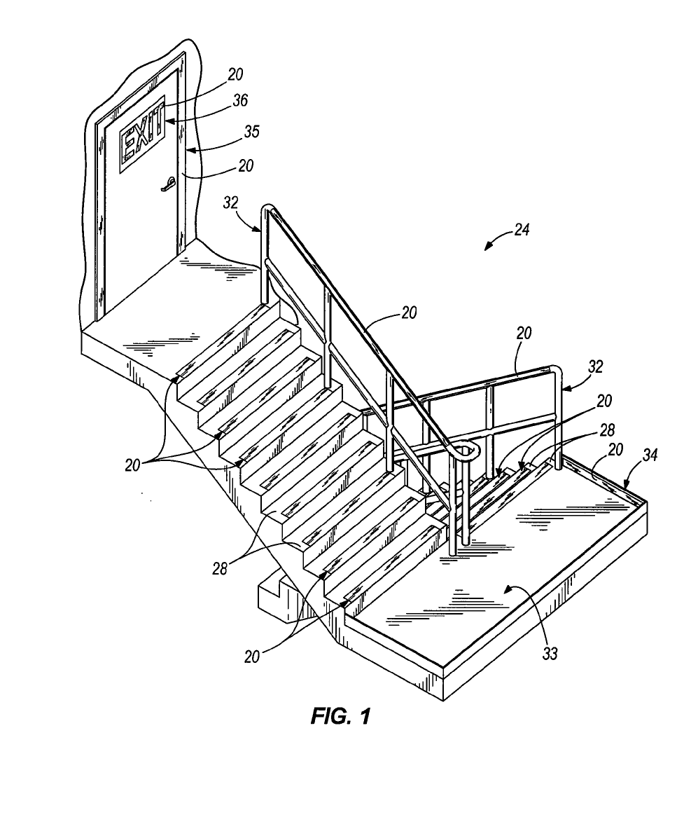

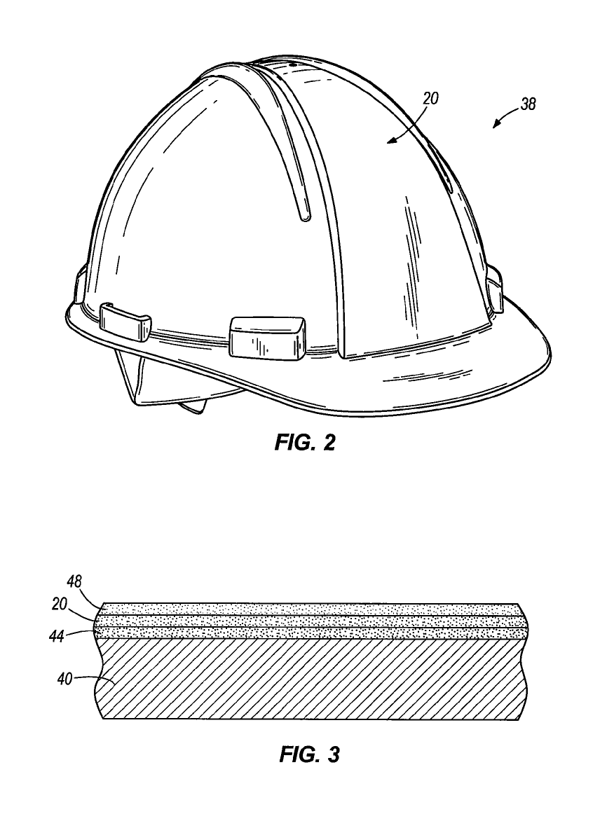

With reference to FIGS. 1 and 2, exemplary applications of urethane based luminescent paints 20 of the present invention are illustrated. More particularly, FIG. 1 illustrates a stairwell 24 in an interior of a building. The luminescent paint 20 may be applied to the stairs 28, the handrail 32, a landing 33, a riser 34, a doorframe 35, and a sign 36. Stairwells 24 are often low light environments under normal conditions. In emergency situations, such as in a fire or a loss of electricity, the stairwell 24 has even lower light conditions than under normal conditions. In such instances, the light emitted by the luminescent paint 20 on the stairs 28, handrails 32, landing 33, riser 34, doorframe 35, and sign 36 may illuminate the stairwell 24 and make it easier for occupants in the stairwell 24 to see the stairs 28, the handrails 32, etc., and other people within the stairwell 24. The luminescent paint 20 is durable and provides a long life on the stairs 28 under heavy foot traffic and on the handrail 32 under heavy hand traffic.

With reference to FIG. 2, a hard hat 38 is illustrated and includes the urethane based luminescent paint 20 on at least an exterior of the hard hat 38. The urethane based luminescent paint may also be applied to an interior of the hard hat 38. Hard hats 38 are typically made of a hard, durable plastic capable of enduring impacts. The luminescent paint 20 is capable of adhering to the material of the hard hat 38 without peeling, cracking, or chipping. Hard hats 38 may be worn in a variety of environments, some of which have low light conditions. In such low light conditions, light emitted by the luminescent paint 20 will increase the hard hat's 38 visibility, thereby inhibiting the occurrence of accidents.

As indicated above, the urethane based luminescent paints of the present invention are capable of having a variety of colors, often referred to as daytime colors, that resist fading. Dyes may be used to color the urethane based luminescent paints and may be in powder form or liquid form. In the powder form, the dye has no solvents and, therefore, does not have any HAPs. In the liquid form, the dye will include some solvent. In some exemplary embodiments, the liquid dye will have a low percentage of HAPs. In other exemplary embodiments, the liquid dye will be free of HAPs. No matter the form in which the dye occupies, the dyes used with the urethane based luminescent paints of the present invention resist fading when exposed to ultraviolet (UV) rays, thereby providing the urethane based luminescent paints containing these types of dyes with colors that have the ability to resist fading. This is contrary to conventional acrylic based luminescent paints, which require water based dyes for compatibility. Such water based dyes are not UV tolerant and will fade easily when exposed to UV rays. The urethane based luminescent paints of the present invention may have colors including, for example, blue, light blue, green, light green, blue-green, yellow, fluorescent yellow, safety yellow, orange, purple, red, and white, that resist fading and have a relatively long, colorful life.

Referring now to FIG. 3, an exemplary application of the urethane based luminescent paints 20 of the present invention is illustrated and will be described herein. This exemplary application is only one of a variety of different manners for applying the luminescent paints 20 to an object 40. In this example, a primer or first coat 44 is applied directly to an object 40. Since the luminescent paints of the present invention are urethane based, the luminescent paints are compatible with a wide variety of primer types such as, for example, acrylic, alkyd, enamels, urethane, epoxy, etc. Also, the primer coat 44 should be in good condition (i.e., not chipping, cracking, or peeling; free of dirt, oil, grease, and other foreign materials). In some examples, it is preferable that the primer coat 44 have a white or light silver color (described in greater detail below). Next, the urethane based luminescent paint 20 may be applied onto the primer coat 44. In some instances, the urethane based luminescent paint 20 may be referred to as the mid-coat. In the illustrated exemplary embodiment, a single coat or layer of urethane based luminescent paint 20 is applied. Alternatively, any number of coats or layers of urethane based luminescent paint 20 may be applied and be within the spirit and scope of the present invention. Finally, a top coat or clear coat 48 may be applied onto the luminescent paint 20. In some examples, the clear coat 48 may be non-yellowing with low UV inhibitors to allow maximum UV penetration therethrough. Also, in some examples, the clear coat 48 may be urethane based, epoxy based, alkyd based, etc. The clear coat 48 may also provides some protection to the luminescent paint 20, thereby improving the paint's 20 overall durability.

In the present example, the luminescent paint 20 is applied to a primer 44. The primer 44 may be a variety of colors, but, typically, primer 44 is white. While the urethane based luminescent paint 20 may be applied to primer 44 having any color, applying the urethane based luminescent paint 20 to a white primer 44 may accentuate the brightness and the color of the luminescent paint 20. Silver is another color that may accentuate the brightness and the color of the luminescent paint 20. These particular primer colors and other similar colors may reflect UV rays that have passed through or by the urethane based luminescent paint 20 back through the paint 20 to increase the paint's 20 exposure to UV rays, thereby improving charging of the luminescent substance within the paint 20.

The urethane based luminescent paint 20 may also be applied directly to an object 40 without a primer layer. While the luminescent paint 20 may be applied to objects 40 having any color, objects 40 having a white or silver color accentuate the brightness and color of the luminescent paint 20 more than other colors for reasons similar to those described above relating to primer colors.

The following description identifies exemplary compositions of and methods of making urethane based luminescent paints of the present invention. The following examples are not meant to be limiting upon the present invention and the urethane based luminescent paints of the present invention are capable of having other compositions and being made by other methods.

A first exemplary urethane based luminescent paint includes a urethane base, an anti-settling agent, and luminescent substance. In this example, the urethane base comprises a polyurethane or urethane resin and a plurality of bio-friendly solvents otherwise known as biosolvents.

The plurality of biosolvents are characterized as bio-friendly due to their lack of hazardous air pollutants (HAPs) and their carbonless or carbon neutral characteristic, which contributes to the biosolvents being biodegradable. Such biosolvents may be made from corn, soy, citrus, vegetable, or other natural products. The urethane based luminescent paints of the present invention are capable of using a wide variety of biosolvents and the biosolvents identified herein are only exemplary biosolvents not intended to be limiting upon the present invention. The following exemplary biosolvents are manufactured by Vertec Biosolvents Inc. of Downers Grove, Ill. 60515 and are accompanied by, in parenthesis, exemplary solvents they replace. Biosolvents may be identified by the non-bio-friendly solvents or HAP containing solvents that the biosolvents are capable of replacing. Exemplary Vertec biosolvents usable with the urethane based luminescent paints of the present invention include: Biosolvent LQ (may replace butyl acetate); Biosolvent PMAR (may replace acetate); Biosolvent ISR (may replace Isophrone); Biosolvent XTR (may replace xylene and toluene); Biosolvent KTR1 (may replace methyl ethyl ketone); and Biosolvent MAKR (may replace methyl amyl ketone).

Also in the present example, the urethane resin may be a wide variety of types of urethane resins that may have low HAP levels or have no HAPs. Urethane resins having either low HAP levels or no HAPs may both be considered bio-friendly urethane resins. An example of a urethane resin usable with the urethane based luminescent paints of the present invention may include Solucote 8980 manufactured by Soluol, Inc. of Providence, R.I. 02915.

Further in the present example, the anti-settling agent may be a wide variety of types of anti-settling agents that may have low HAP levels or have no HAPs. Anti-settling agents having either low HAP levels or no HAPs may both be considered bio-friendly anti-settling agents. Exemplary anti-settling agents useable with the urethane based luminescent paints of the present invention may be either in liquid form or solid form (e.g., powder) and may include Y25X anti-settling product or Garamite 1958 anti-settling product manufactured by Southern Clay Products, Inc. of Gonzales, Tex. 78629, or Disparlon 4200-20 manufactured by King Industries of Norwalk, Conn. 06852.

Further yet in the present example, the luminescent substance may be strontium aluminate europium and may be one of a variety of products manufactured by MPK Co. of Clayton, Wis. 54004. Such examples of luminescent substance include the following MPK Co. products: MMHSB-8D; MMHSB-9C; MMHSB-9D; MMHG-5B; MMHB-4B; MMSWW-4D. In these examples of the luminescent substance, the number immediately following the “-” in the product numbers represents a color and the letter following the number represents the size of the luminescent substance particle. For example, the letter “B” represents the largest particle size and the letter “F” represents the smallest particle size with the letters between “B” and “E” representing particle sizes decreasing in size from “B” to “E”. The larger the luminescent substance particle size the longer and brighter the luminescent substance particle will emit light. Different luminescent substance particle sizes are used for different colors of the exemplary luminescent paints. The luminescent substance particle size selected for each color of paint was selected because it performed best with that particle color. Alternatively, the present example may include luminescent substance products manufactured by other entities such as WGR1-OW-12-18 manufactured by Color Technology of Howell, N.J. 07731 or MR-1 manufactured by Yangzhou Huahan Plastic Colour Masterbatch Co. Ltd. of Yangzhou City, Jiangsu Province, China. Luminescent substances used with the urethane based luminescent paints of the present invention do not include any HAPs.

The exemplary urethane based luminescent paints of the present invention may have a variety of different colors and the compositions of the luminescent paints may differ depending on the desired color. Dyes may be added to the urethane based luminescent paints in order to establish a desired color other than white. A variety of different types of dyes may be used to obtain the desired colors of the urethane based luminescent paints. The dyes identified below are for exemplary purposes and are not intended to be limiting upon the present invention. Dyes used with the urethane based luminescent paints may include low levels of HAPs or may include no HAPs, all of which may be considered bio-friendly dyes.

The following exemplary colors and compositions are for illustrative purposes only and provide some of the many possible colors and compositions.

If a white urethane based luminescent paint is desired, the paint may include the following quantities of components: 27.3 liquid ounces of urethane resin, 18.2 liquid ounces of Biosolvent LQ, 18.2 liquid ounces of Biosolvent PMAR, 9.1 liquid ounces of Biosolvent ISR, 9.1 liquid ounces of XTR, 9.1 liquid ounces of Biosolvent KTR1, 9.1 liquid ounces of Biosolvent MAKR, 28 liquid ounces of anti-settling agent, and 1 kilogram of MMSWW-4D luminescent substance. As indicated above, dye may not be added if white is the desired color of the luminescent paint. However, a white dye may be added if desired.

If a yellow urethane based luminescent paint is desired, the paint may include the following quantities of components: 27.3 liquid ounces of urethane resin, 18.2 liquid ounces of Biosolvent LQ, 18.2 liquid ounces of Biosolvent PMAR, 9.1 liquid ounces of Biosolvent ISR, 9.1 liquid ounces of XTR, 9.1 liquid ounces of Biosolvent KTR1, 9.1 liquid ounces of Biosolvent MAKR, 28 liquid ounces of anti-settling agent, 1 kilogram of MMHG-5B luminescent substance, and 16 grams of Parasol Yellow 5G-98 dye manufactured by Paramount Colors Inc. of Elk Grove Village, Ill. 60007. All “Parasol” dyes are manufactured by Paramount Colors Inc.

An alternative yellow urethane based luminescent paint is similar to the previous yellow paint, except this alternative yellow paint includes a different type of luminescent substance and a different quantity of dye. More particularly, this alternative yellow paint includes 1 kilogram of MMSWW-4D luminescent substance and 15 grams of Parasol Yellow 5G-98 dye.

Another alternative yellow urethane based luminescent paint is similar to the previous yellow paints, except this alternative yellow paint includes a combination of luminescent substances to arrive at 1 kilogram of total luminescent substance mass and includes different types and quantities of dyes. More particularly, this alternative yellow paint includes 0.5 kilograms of MMSWW-4D luminescent substance, 0.5 kilograms of MMHG-5B luminescent substance, 5 grams of Parasol Yellow 10GN-160 dye, and 2 grams of Parasol Blue 3R dye.

If a fluorescent yellow urethane based luminescent paint is desired, the paint may include the following quantities of components: 27.3 liquid ounces of urethane resin, 18.2 liquid ounces of Biosolvent LQ, 18.2 liquid ounces of Biosolvent PMAR, 9.1 liquid ounces of Biosolvent ISR, 9.1 liquid ounces of XTR, 9.1 liquid ounces of Biosolvent KTR1, 9.1 liquid ounces of Biosolvent MAKR, 28 liquid ounces of anti-settling agent, 1 kilogram of MMHG-5B luminescent substance, and 16 grams of Parasol Yellow 10GN-160 dye.

An alternative fluorescent yellow urethane based luminescent paint is similar to the previous fluorescent yellow paint, except this alternative fluorescent yellow paint includes a different type of luminescent substance and a different quantity of dye. More particularly, this alternative fluorescent yellow paint includes 1 kilogram of MMSWW-4D luminescent substance and 5 grams of Parasol Yellow 10GN-160 dye.

Another alternative fluorescent yellow urethane based luminescent paint is similar to the previous fluorescent yellow paints, except this alternative fluorescent yellow paint includes a combination of luminescent substances to arrive at 1 kilogram of total luminescent substance mass and includes a different quantity of dye. More particularly, this alternative fluorescent yellow paint includes 0.5 kilograms of MMSWW-4D luminescent substance, 0.5 kilograms of MMHG-5B luminescent substance, and 5 grams of Parasol Yellow 10GN-160 dye.

If an orange urethane based luminescent paint is desired, the paint may include the following quantities of components: 27.3 liquid ounces of urethane resin, 18.2 liquid ounces of Biosolvent LQ, 18.2 liquid ounces of Biosolvent PMAR, 9.1 liquid ounces of Biosolvent ISR, 9.1 liquid ounces of XTR, 9.1 liquid ounces of Biosolvent KTR1, 9.1 liquid ounces of Biosolvent MAKR, 28 liquid ounces of anti-settling agent, 1 kilogram of MMHG-5B luminescent substance, 7 grams of Parasol Yellow 10GN-160 dye, and 7 grams of Parasol Red GK-197 dye.

An alternative orange urethane based luminescent paint is similar to the previous orange paint, except this alternative orange paint includes a different type of luminescent substance. More particularly, this alternative orange paint includes 1 kilogram of MMSWW-4D luminescent substance.

Another alternative orange urethane based luminescent paint is similar to the previous orange paints, except this alternative orange paint includes a combination of luminescent substances to arrive at 1 kilogram of total luminescent substance mass. More particularly, this alternative orange paint includes 0.5 kilograms of MMSWW-4D luminescent substance and 0.5 kilograms of MMHG-5B luminescent substance.

Yet another alternative orange urethane based luminescent paint is similar to the previous orange paints, except this alternative orange paint includes a different combination of luminescent substances to arrive at 1 kilogram of total luminescent substance mass and includes different quantities of dyes. More particularly, this alternative orange paint includes 0.7 kilograms of MMSWW-4D luminescent substance, 0.3 kilograms of WGR1-OW-12-18 luminescent substance, 5 grams of Parasol Yellow 10GN-160 dye, and 2 grams of Parasol Red GK-197 dye.

In further alternative orange urethane based luminescent paints, other types of dyes may be used to color the paint a desired color. Such dyes may include, for example, Parasol BK 196, Parasol GK 197, Parasol AB23, and Parasol A 24, all of which are manufactured by Paramount Colors Inc. of Elk Grove Village, Ill. 60007.

If a light blue urethane based luminescent paint is desired, the paint may include the following quantities of components: 27.3 liquid ounces of urethane resin, 18.2 liquid ounces of Biosolvent LQ, 18.2 liquid ounces of Biosolvent PMAR, 9.1 liquid ounces of Biosolvent ISR, 9.1 liquid ounces of XTR, 9.1 liquid ounces of Biosolvent KTR1, 9.1 liquid ounces of Biosolvent MAKR, 28 liquid ounces of anti-settling agent, 1 kilogram of MMHB-4B luminescent substance, and 8 grams of Parasol Blue 3R dye.

If a blue urethane based luminescent paint is desired, the paint may include the following quantities of components: 27.3 liquid ounces of urethane resin, 18.2 liquid ounces of Biosolvent LQ, 18.2 liquid ounces of Biosolvent PMAR, 9.1 liquid ounces of Biosolvent ISR, 9.1 liquid ounces of XTR, 9.1 liquid ounces of Biosolvent KTR1, 9.1 liquid ounces of Biosolvent MAKR, 28 liquid ounces of anti-settling agent, 1 kilogram of MMHSB-9D luminescent substance, and 16 grams of Parasol Blue L-104 dye.

If a light green urethane based luminescent paint is desired, the paint may include the following quantities of components: 27.3 liquid ounces of urethane resin, 18.2 liquid ounces of Biosolvent LQ, 18.2 liquid ounces of Biosolvent PMAR, 9.1 liquid ounces of Biosolvent ISR, 9.1 liquid ounces of XTR, 9.1 liquid ounces of Biosolvent KTR1, 9.1 liquid ounces of Biosolvent MAKR, 28 liquid ounces of anti-settling agent, 1 kilogram of MMHG-5B luminescent substance, 5 grams of Parasol Yellow 10GN-160 dye, and 2 grams Parasol Blue 3R.

If a green urethane based luminescent paint is desired, the paint may include the following quantities of components: 27.3 liquid ounces of urethane resin, 18.2 liquid ounces of Biosolvent LQ, 18.2 liquid ounces of Biosolvent PMAR, 9.1 liquid ounces of Biosolvent ISR, 9.1 liquid ounces of XTR, 9.1 liquid ounces of Biosolvent KTR1, 9.1 liquid ounces of Biosolvent MAKR, 28 liquid ounces of anti-settling agent, 1 kilogram of MMHG-5B luminescent substance, 10 grams of Parasol Yellow 10GN-160 dye, and 4 grams Parasol Blue 3R.

If a safety yellow urethane based luminescent paint is desired, the paint may include the following quantities of components: 27.3 liquid ounces of urethane resin, 18.2 liquid ounces of Biosolvent LQ, 18.2 liquid ounces of Biosolvent PMAR, 9.1 liquid ounces of Biosolvent ISR, 9.1 liquid ounces of XTR, 9.1 liquid ounces of Biosolvent KTR1, 9.1 liquid ounces of Biosolvent MAKR, 28 liquid ounces of anti-settling agent, 1 kilogram of MMHG-5B luminescent substance, 10 grams of Parasol Yellow 10GN-160 dye, and 4 grams Parasol Red GK-197.

If a purple urethane based luminescent paint is desired, the paint may include the following quantities of components: 27.3 liquid ounces of urethane resin, 18.2 liquid ounces of Biosolvent LQ, 18.2 liquid ounces of Biosolvent PMAR, 9.1 liquid ounces of Biosolvent ISR, 9.1 liquid ounces of XTR, 9.1 liquid ounces of Biosolvent KTR1, 9.1 liquid ounces of Biosolvent MAKR, 28 liquid ounces of anti-settling agent, 1 kilogram of MMHSB-9D luminescent substance, 7 grams of Parasol Blue L-104 dye, and 7 grams Parasol Red A-24.

If a red urethane based luminescent paint is desired, the paint may include the following quantities of components: 27.3 liquid ounces of urethane resin, 18.2 liquid ounces of Biosolvent LQ, 18.2 liquid ounces of Biosolvent PMAR, 9.1 liquid ounces of Biosolvent ISR, 9.1 liquid ounces of XTR, 9.1 liquid ounces of Biosolvent KTR1, 9.1 liquid ounces of Biosolvent MAKR, 28 liquid ounces of anti-settling agent, 1 kilogram of WGR-OW-12-18 luminescent substance, and 16 grams of Parasol Red PH.

In alternative red urethane based luminescent paints, other types of dyes may be used to color the paint a desired color. Such dyes may include, for example, Parasol BK 196, Parasol GK 197, Parasol AB23, and Parasol A 24, all of which are manufactured by Paramount Colors Inc. of Elk Grove Village, Ill. 60007.

In some exemplary embodiments, another substance or filler may be added to the urethane based luminescent paint in order to provide additional beneficial characteristics to the urethane based luminescent paint. Such beneficial characteristics may include, for example, thickening the paint so less coats or layers of paint are required to provide adequate coverage, increasing durability of the paint, increasing uniformity of the paint, assisting with color retention, and increasing the paint's chemical and stain resistance. The filler may be a variety of different products including, for example, silica flour, Nepheline Syenite, etc. One of the many examples of silica flour useable with the urethane based luminescent paint may include silica flour provided by AGSCO of Wheeling, Ill. Two of the many examples of Nepheline Syenite useable with the urethane based luminescent paint may include Minex 3 and Minex 4 provided by Uninim Specialty Minerals, Inc. of New Canaan, Conn. The filler may be added to any of the exemplary urethane based luminescent paints described above and other possible urethane based luminescent paints of the present invention. Also, various quantities of filler may be added to the urethane based luminescent paint. In one exemplary embodiment, 500 grams of filler per gallon of paint may be added to the urethane based luminescent paint. In other exemplary embodiments, anywhere from 0.1 grams to 1000 grams of filler per gallon of paint may be added to the urethane based luminescent paint. Other quantities of filler are contemplated and are within the intended spirit and scope of the present invention. The full quantity of filler added to the urethane based luminescent paint may be comprised of either a single type of filler or may be comprised of multiple types of filler. For example, in instances where a single type of filler is added, the total quantity of filler may be comprised of silica flour or the total quantity of filler may be comprised of Nepheline Syenite. Also for example, in instances where multiple types of filler are added, a first portion of the total quantity of filler may be comprised of silica flour and the remaining portion of the filler may be comprised of Nepheline Syenite. The filler may also be comprised of a wide variety of different particle sizes. In some exemplary embodiments, the size of the particles comprising the filler may be between about 37 microns and about 74 microns. Other particle sizes of the filler are possible and are within the spirit and scope of the present invention. Smaller particle sizes may be desired in applications where a smooth, non-gritty urethane based luminescent paint is desired. One such exemplary application may include automotive exterior paint. Larger particle sizes may be desired in applications where a rougher, gritty, and/or anti-skid urethane based luminescent paint is desired. One such exemplary application may include steps in a stairwell.

In the above exemplary colors of the first exemplary urethane based luminescent paint, the various components of the paint comprise the following percentages of the total weight of the paint: urethane base comprises between about 50% and about 62% of the total weight; anti-settling agent comprises between about 14% and about 18% of the total weight; dye comprises between about 0% and about 1% of the total weight; luminescent substance comprises between about 17% and about 22% of the total weight; and filler comprises between 0% and about 20% of the total weight. Alternatively, the various components of the paint may comprise other percentages of the total weight of the first exemplary urethane based luminescent paint. For example, the various components may comprise the following percentages of the total weight of the paint: Urethane base may comprise between about 5% and about 85% of the total weight; anti-settling agent may comprise between about 1% and about 60% of the total weight; dye may comprise between 0% and about 5% of the total weight; luminescent substance may comprise between about 0.001% and about 60% of the total weight; and filler may comprise between about 0% and about 35%.

In this first exemplary embodiment, the urethane base comprises a variety of exemplary components, each of which comprises a percentage of the total weight of the urethane based luminescent paint. For example, the components of the urethane base and their percentages of the total weight of the paint are as follows: urethane resin comprises between about 13% and about 17% of the total weight; biosolvent LQ comprises between about 9% and about 12% of the total weight; biosolvent PMAR comprises between about 9% and about 12% of the total weight; biosolvent ISR comprises between about 4% and about 6% of the total weight; biosolvent XTR comprises between about 4% and about 6% of the total weight; biosolvent KTR1 comprises between about 4% and about 6% of the total weight; and biosolvent MAKR comprises between about 4% and about 6% of the total weight. Alternatively, the various components of the urethane base may comprise other percentages of the total weight of the urethane based luminescent paint. For example, the various components of the urethane base may comprise the following percentages of the total weight of the paint: the urethane resin may comprise between about 5% and about 65% of the total weight; biosolvent LQ may comprise between about 1% and about 45% of the total weight; biosolvent PMAR may comprise between about 1% and about 45% of the total weight; biosolvent ISR may comprise between 1% and about 45% of the total weight; biosolvent XTR may comprise between about 1% and about 45% of the total weight; biosolvent KTR1 may comprise between about 1% and about 45% of the total weight; and biosolvent MAKR may comprise between about 1% and about 45% of the total weight.

Another manner in which to consider the first exemplary urethane based luminescent paint is by the components that comprise solvents and the components that comprise non-solvents. In this example, the solvents comprise the biosolvents, a portion of the urethane resin, and a portion of the anti-settling agent, and the non-solvents comprise a portion of the anti-settling agent, a portion of the urethane resin, the dye, the luminescent substance, and the filler. The solvents and non-solvents used in this exemplary urethane based paint are exemplary and a variety of other solvents and non-solvents may be used with the urethane based luminescent paint and still be within the spirit and scope of the invention. In this first exemplary urethane based luminescent paint, the urethane resin comprises about 40% non-solvents and about 60% solvents, and the anti-settling agent comprises about 25% non-solvents and about 75% solvents. Alternatively, the urethane resin and anti-settling agent may comprises other percentages of solvents and non-solvents and be within the intended spirit and scope of the present invention. In the first exemplary urethane based luminescent paint, the solvents in combination comprise between about 55% and about 68% of the total weight and the non-solvents comprise between about 32% and about 45% of the total weight. Alternatively, the solvents and non-solvents may comprise other percentages of the total weight of the urethane based luminescent paint. For example, the solvents in combination may comprise between about 30% and about 80% of the total weight of the paint. Also, for example, the non-solvents in combination may comprise between about 20% and about 70% of the total weight of the paint.

A further manner in which to consider the first exemplary urethane based luminescent paint is by the components of the paint that comprise biosolvents. In this example, the biosolvents by percentage of the total weight of the paint range between about 36% and about 45%. Alternatively, the biosolvents may comprise other percentages of the total weight of the urethane based luminescent paint. For example, the biosolvents may comprise between about 1% and about 65% of the total weight of the urethane based luminescent paint.

Yet another manner in which to consider the first exemplary urethane based luminescent paint is by the percentage of HAPs present in the paint. In some exemplary embodiments of the first exemplary urethane based luminescent paint, the anti-settling agent and the urethane resin may both have a small percentage by total weight of HAPs present therein, with the remaining components of the paint free of HAPs. For example, HAPs may comprise between about 18% and about 20% of the anti-settling agent and between about 6% and about 8% of the urethane resin. Such exemplary ranges of HAPs present in the anti-settling agent and the urethane resin result in the overall urethane based luminescent paint comprising between about 3% and about 5% of HAPs of the total weight of the paint. In other exemplary embodiments of the first exemplary urethane based luminescent paint, only the anti-settling agent may have a small percentage by total weight of HAPs present therein, with all the remaining components of the paint free of HAPs. For example, HAPs may comprise between about 18% and about 20% of the anti-settling agent. Such an exemplary range of HAPs present in the anti-settling agent results in the overall urethane based luminescent paint comprising between about 2% and about 4% of HAPs of the total weight of the paint. In further exemplary embodiments of the first exemplary urethane based luminescent paint, only the urethane resin may have a small percentage by total weight of HAPs present therein, with all the remaining components of the paint free of HAPs. For example, HAPs may comprise between about 6% and about 8% of the urethane resin. Such an exemplary range of HAPs present in the urethane resin results in the overall urethane based luminescent paint comprising between about 0.75% and about 1.5% of HAPs of the total weight of the paint. In yet other exemplary embodiments of the first exemplary urethane based luminescent paint, the urethane based luminescent paint is completely free of HAPs. That is, none of the components of the first exemplary urethane based luminescent paint include HAPs therein.

A second exemplary urethane based luminescent paint is described hereinafter. The second exemplary urethane based luminescent paint is capable of having all of the same exemplary colors described above with respect to the first exemplary urethane based luminescent paint, but the various colors of the second exemplary urethane based luminescent paint have different compositions than the various colors of the first exemplary urethane based luminescent paint described above. In general, the second exemplary urethane based luminescent paint includes an anti-settling agent in powder form rather than a liquid form as is the case in the first exemplary urethane based luminescent paint, and includes additional liquid ounces of solvent to compensate for the loss of the solvent present in the liquid anti-settling agent of the first exemplary urethane based luminescent paint. The additional solvent added to the second exemplary urethane based luminescent paint may be accounted for by any of the biosolvents in any quantity. For example, the additional solvent may be accounted for by a single one of the biosolvents or the additional solvent may be divided up amongst any number of the biosolvents in any quantities.

As indicated above, the second exemplary urethane based luminescent paint may have all of the exemplary colors identified above in connection with the first exemplary urethane based luminescent paint except that the compositions of the exemplary colors of the second exemplary urethane based luminescent paint will replace the 28 liquid ounces of anti-settling agent, from the first exemplary urethane based luminescent paint, with a quantity of anti-settling agent powder and an additional quantity of biosolvent. For example, 128 grams of anti-settling agent powder and 28 liquid ounces of additional biosolvent may replace the liquid anti-settling agent from the first exemplary urethane based luminescent paint. The 28 liquid ounces of additional biosolvent may be accounted for by any single biosolvent or any combination of the biosolvents.

It should be understood that the quantities of anti-settling agent powder and additional biosolvent identified above are for illustrative purposes only and are only some of the many possible quantities of anti-settling agent powder and biosolvent that may be included in the second exemplary urethane based luminescent paint. The listed quantities of anti-settling agent powder and biosolvents are not intended to be limiting and many other quantities are contemplated and within the intended spirit and scope of the present invention.

Similar to the first exemplary urethane based paint described above, this second exemplary urethane based paint and all of its colors described above may, in some exemplary embodiments, include another substance or filler in order to provide additional beneficial characteristics to the second exemplary urethane based luminescent paint. The remarks above pertaining to the filler added to the first exemplary urethane based paint also apply to the second exemplary urethane based luminescent paint and, for the sake of brevity, will not be repeated here.

In the exemplary colors of the second exemplary urethane based luminescent paint, the various components of the paint may comprise the following percentages of the total weight of the paint: urethane base comprises between about 62% and about 77% of the total weight; anti-settling agent (i.e., powder) comprises between about 2% and about 3% of the total weight; dye comprises between about 0% and about 1% of the total weight; luminescent substance comprises between about 17% and about 22% of the total weight; and filler comprises between 0% and about 20%. Alternatively, the various components of the paint may comprise other percentages of the total weight of the second exemplary urethane based luminescent paint. For example, the various components may comprise the following percentages of the total weight of the paint: Urethane base may comprise between about 5% and about 85% of the total weight; anti-settling agent (i.e., powder) may comprise between about 0.25% and about 20% of the total weight; dye may comprise between 0% and about 5% of the total weight; luminescent substance may comprise between about 0.001% and about 60% of the total weight; and filler may comprise between 0% and about 35%.

In this second exemplary embodiment, the urethane base comprises a variety of exemplary components, each of which comprises a percentage of the total weight of the urethane based luminescent paint. As indicated above, the second exemplary urethane based luminescent paint includes an additional 28 liquid ounces of biosolvents that may be accounted for by any single biosolvent or any combination of biosolvents. The following exemplary ranges of percentages of total weight of the biosolvents account for instances where the biosolvents include a maximum amount of the additional 28 liquid ounces of biosolvent (i.e., instances where a single biosolvent accounts for all the additional biosolvent) and for instances where the biosolvents include the minimum amount of the additional quantity of biosolvent (i.e., 0 liquid ounces of the additional biosolvent). For example, the components of the urethane base and their percentages of the total weight of the paint are as follows: urethane resin comprises between about 13% and about 17% of the total weight; biosolvent LQ comprises between about 8% and about 28% of the total weight; biosolvent PMAR comprises between about 8% and about 28% of the total weight; biosolvent ISR comprises between about 4% and about 23% of the total weight; biosolvent XTR comprises between about 4% and about 23% of the total weight; biosolvent KTR1 comprises between about 4% and about 23% of the total weight; and biosolvent MAKR comprises between about 4% and about 23% of the total weight. Alternatively, the various components of the urethane base may comprise other percentages of the total weight of the urethane based luminescent paint. For example, the various components of the urethane base may comprise the following percentages of the total weight of the paint: the urethane resin may comprise between about 5% and about 65% of the total weight; biosolvent LQ may comprise between about 1% and about 60% of the total weight; biosolvent PMAR may comprise between about 1% and about 60% of the total weight; biosolvent ISR may comprise between 1% and about 60% of the total weight; biosolvent XTR may comprise between about 1% and about 60% of the total weight; biosolvent KTR1 may comprise between about 1% and about 60% of the total weight; and biosolvent MAKR may comprise between about 1% and about 60% of the total weight.

Another manner in which to consider the second exemplary urethane based luminescent paint is by the components that comprise solvents and the components that comprise non-solvents. In this example, the solvents comprise the biosolvents and a portion of the urethane resin, and the non-solvents comprise the anti-settling agent (i.e., powder), a portion of the urethane resin, the dye, the luminescent substance, and the filler. The second exemplary urethane based luminescent paint is different than the first exemplary urethane based luminescent paint in that the anti-settling agent in the second exemplary paint comprises all non-solvent (i.e., powder) rather than the anti-settling agent comprising part solvent and part non-solvent as in the first exemplary paint. The solvents and non-solvents used in this second exemplary urethane based paint are exemplary and a variety of other solvents and non-solvents may be used with the second urethane based luminescent paint and still be within the spirit and scope of the invention. In this second exemplary urethane based luminescent paint, the urethane resin comprises about 40% non-solvents and about 60% solvents. Alternatively, the urethane resin may comprises other percentages of solvents and non-solvents and be within the intended spirit and scope of the present invention. In the second exemplary urethane based luminescent paint, the solvents in combination comprise between about 57% and about 71% of the total weight and the non-solvents in combination comprise between about 29% and about 43% of the total weight. Alternatively, the solvents and non-solvents may comprise other percentages of the total weight of the second exemplary urethane based luminescent paint. For example, the solvents in combination may comprise between about 30% and about 80% of the total weight of the paint. Also, for example, the non-solvents in combination may comprise between about 20% and about 70% of the total weight of the paint.

A further manner in which to consider the second exemplary urethane based luminescent paint is by the components of the paint that comprise biosolvents. In this example, the biosolvents by percentage of the total weight of the paint range between about 49% and about 61%. Alternatively, the biosolvents may comprise other percentages of the total weight of the urethane based luminescent paint. For example, the biosolvents may comprise between about 1% and about 80% of the total weight of the second urethane based luminescent paint.

Yet another manner in which to consider the second exemplary urethane based luminescent paint is by the percentage of HAPs present in the paint. In some exemplary embodiments of the second exemplary urethane based luminescent paint, only the urethane resin may have a small percentage by total weight of HAPs present therein, with the remaining components of the paint free of HAPs. For example, HAPs may comprise between about 6% and about 8% of the urethane resin. Such an exemplary range of HAPs present in the urethane resin results in the overall urethane based luminescent paint comprising between about 0.75% and about 1.5% of HAPs of the total weight of the paint. In other exemplary embodiments of the second exemplary urethane based luminescent paint, the urethane based luminescent paint is completely free of HAPs. That is, none of the components of the second exemplary urethane based luminescent paint include HAPs therein.

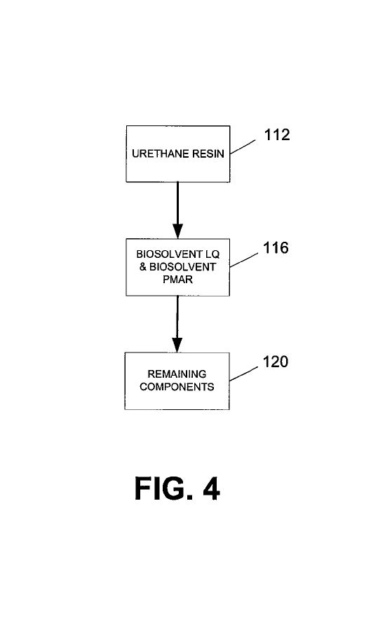

With reference to FIG. 4, an exemplary method of making the exemplary urethane based luminescent paints is illustrated and will be described herein. This is only one of many different methods of making the exemplary paints and this example is not intended to be limiting. Many other methods of making the exemplary urethane based luminescent paints are contemplated and are within the spirit and scope of the present invention.

The first step in this exemplary method of making urethane based luminescent paint includes beginning with the full quantity of urethane resin (step 112). Next, the total quantities of biosolvent LQ and biosolvent PMAR are added to the urethane resin and mixed until evenly blended (step 116). The components of this exemplary urethane based luminescent paint may be mixed in a variety of manners such as, for example, stirring or shaking. In some examples, stirring may be performed with a plastic stirring element. After this mixture is evenly blended, the total quantities of the remaining components (i.e., biosolvents ISR, XTR, KTR1, and MAKR; anti-settling agent; luminescent substance; dye; and filler) are added and mixed until evenly blended (step 120). Upon creating an evenly blended mixture including all the above components, the exemplary urethane based luminescent paint is completed. The amount of time required to make this luminescent paint may vary. In some examples, the total amount of time required to make this luminescent paint ranges between about 10 minutes and about 20 minutes.

It should be understood that the previously described method of making the exemplary urethane based luminescent paints is for exemplary purposes only and that the components of the paints can be mixed in different amounts and in different orders and still be within the spirit and scope of the present invention. For example, dye or filler may be added at anytime during the paint making process of the above exemplary urethane based luminescent paints. Also, for example, various quantities of the components may be added to the mixture at various times throughout the paint making process.

The foregoing description has been presented for purposes of illustration and description, and is not intended to be exhaustive or to limit the invention to the precise form disclosed. The descriptions were selected to explain the principles of the invention and their practical application to enable others skilled in the art to utilize the invention in various embodiments and various modifications as are suited to the particular use contemplated. Although particular constructions of the present invention have been shown and described, other alternative constructions will be apparent to those skilled in the art and are within the intended scope of the present invention.

What is claimed is:

1. A luminescent paint having a composition comprising, as a percentage of weight:
about 5% to about 65% urethane resin;
about 0.001% to about 60% luminescent substance; and
less than or equal to about 5% hazardous air pollutant.

2. The luminescent paint of claim 1, wherein the percentage by weight of urethane resin is about 13% to about 17%.

3. The luminescent paint of claim 2, wherein the percentage by weight of luminescent substance is about 17% to about 22%.

4. The luminescent paint of claim 3, wherein the percentage by weight of hazardous air pollutant is about 0.75% to about 5%.

5. The luminescent paint of claim 3, wherein the percentage by weight of hazardous air pollutant is about 2% to about 5%.

6. The luminescent paint of claim 3, wherein the percentage by weight of hazardous air pollutant is 0%.

7. The luminescent paint of claim 1, wherein the percentage by weight of hazardous air pollutant is about 0.75% to about 5%.

8. The luminescent paint of claim 1, wherein the percentage by weight of hazardous air pollutant is about 2% to about 5%.

9. The luminescent paint of claim 1, wherein the percentage by weight of hazardous air pollutant is 0%.

10. A luminescent paint composition comprising:
urethane resin;
luminescent substance; and
a solvent derived from at least one of corn, soy, citrus, and vegetable.

11. The luminescent paint of claim 10, wherein the solvent is biodegradable.

12. The luminescent paint of claim 10, wherein the luminescent paint composition comprises, as a percentage by weight, less than 5% hazardous air pollutant.

13. The luminescent paint of claim 12, wherein the solvent is not a hazardous air pollutant.

14. The luminescent paint of claim 10, wherein the solvent comprises, as a percentage of weight of the luminescent paint composition, about 1% to about 80%.

15. The luminescent paint of claim 10, wherein the solvent comprises, as a percentage of weight of the luminescent paint composition, about 36% to about 61%.

16. The luminescent paint of claim 10, wherein the solvent is one of a plurality of solvents derived from at least one of corn, soy, citrus, and vegetable, and wherein the plurality of solvents comprise, as a percentage of weight of the luminescent paint composition, about 1% to about 80%.

17. The luminescent paint of claim 10, wherein the solvent is one of a plurality of solvents derived from at least one of corn, soy, citrus, and vegetable, and wherein the plurality of solvents comprise, as a percentage by weight of the luminescent paint composition, about 36% to about 61%.
